(19) United States
(12) Patent Application Publication
(10) Pub. No.: US 2005/0080712 A1
(43) Pub. Date: Apr. 14, 2005

(54) Online bidding system with interactive voice recognition interface

(76) Inventors: David J. Bauer, Lafeyette, CA (US); Aaron J. Adair, Fairfield, CA (US)

Correspondence Address: HOWREY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 10/876,751

(22) Filed: Jun. 25, 2004

Related U.S. Application Data
(63) Continuation-in-part of application No. 10/627,547, filed on Jul. 25, 2003.
(60) Provisional application No. 60/479,716, filed on Jun. 18, 2003.

(51) Int. Cl. G06F 17/60

(52) U.S. Cl. 705/37

(57) ABSTRACT

An online auction system comprising a preliminary bidding portion and a virtual auction portion is disclosed herein. The preliminary bidding portion allows bidders to access auction items and input bids during a preestablished period of time. This preliminary bidding portion may be conducted via computers connected to the internet or via telephones connected to the public telephone network. After the preliminary bidding portion concludes, the virtual auction portion allows bidders to input bids on each item in a manner similar to a conventional live auction. During the virtual auction portion, a countdown encourages further bidding before the previous bid becomes final. After each new bid is inputted, the countdown is reinitiated. An alert system notifies bidders that a particular item of interest is about to be offered for bid as part of the virtual auction portion. The system also provides bidders means for inputting proxy bids.

### CROSS-REFERENCE TO RELATED APPLICATIONS

This application is a continuation-in-part of application Ser. No. 10/627,547, filed Jul. 25, 2003, which claims the benefit of provisional Application No. 60/479,716, filed Jun. 18, 2003.

### FIELD OF THE INVENTION

The embodiments of the present invention relate to an auction facilitated by a computer network. More particularly, a global computer network that provides a framework for implementing a unique auction system.

### BACKGROUND

The Internet is the most-widely recognizable global computer network in existence. The computers of the Internet are linked via globally unique address space called Internet Protocol (IP) addresses. Since its explosion in the early 1990s, the Internet has enhanced the prosperity of businesses related to everything from gaming to music to retail sales. In fact, as more and more people have gained access to the Internet and have learned to effectively navigate the Internet, Internet sales have continued to increase at an incredible rate. One extremely successful online business venture has been the advent of the online auction.

For their part, online auctions have reduced auctioneer fraud and collusion between a live auctioneer and live bidders. In addition, online auctions are limitless in their scope. Because of their ease of use, online auctions attract millions of sellers and buyers each and every day for the sole purpose of auctioning off and buying goods. Clearly, live auctions of such a scale are not realistic where bidders must be physically present.

Traditionally, live auctions utilize a format whereby items put up for bid are placed on an auction sale list. Thereafter, the listed items are auctioned consecutively at a preestablished data and time. When the live auction begins, one listed item at a time is auctioned off until no items remain. The auction on individual items ends when no further bids are submitted.

In contrast, typical online auctions allow for multiple items to be auctioned simultaneously. The start and finish time for the online auction items is independent from the other items being auctioned. Additionally, online auctions end at a preestablished time rather than when no further bids are submitted.

Even though the recognized auction websites are very successful, the current online auction format is slow, cumbersome and frequently inefficient in garnering a maximum sales price for the items being auctioned. By way of one example, typical online auctions allow sellers to auction items for a preestablished duration of time (e.g. 5 days). When bidders go online to access and view a particular item of interest, they are provided a record of the time remaining until the auction ends. As people bid for a particular item, they can only hope that another bidder does not bid so close to the end of the auction that it is then impossible for the original bidder to place another bid. Of course, under the existing online auction format such intentional late bidding is a frequent and planned occurrence. Moreover, this online auction format does not encourage any true bidding “frenzy” until the last few minutes of the auction. Unfortunately, for sellers this online auction format does not always result in a bidding environment that allows the seller to maximize the sales price of their item up for auction. In other words, just as the bidding “frenzy” has started, the bidding is routinely terminated according to the preestablished time set for the auction's expiration.

Therefore, there is a need for an online auction system that provides sellers with a legitimate opportunity to maximize returns, while retaining the inherent benefits for both sellers and buyers of conventional online auction systems.

### SUMMARY

Accordingly, the embodiments of the present invention provide a preestablished time duration during which online bidders may bid on presented items simultaneously (hereinafter referred to as “preliminary bidding”). However, the duration of time acts as a countdown to a beginning of a virtual auction rather than a countdown associated with an end of the auction. The preliminary bidding portion of the auction allows online bidders to view all items being sold and to place bids in a manner analogous to current online auction sites. However, once the preliminary bidding portion ends, the virtual or dynamic auction portion begins and is conducted in a fashion analogous to a traditional live auction (hereinafter referred to as “virtual auction”). Therefore, during the virtual auction portion items are auctioned in a consecutive fashion.

The initial bid for the virtual auction may be the final high bid obtained from the preliminary bidding portion. Once the virtual auction begins, online bidders may continue to submit bids until no further bids are forthcoming. For example, if an item up for bid as part of the preliminary bidding portion ends with a current high bid of $500, the virtual auction portion may open with a beginning bid of $500. Bidders are then provided the opportunity to input a higher bid within a preestablished time period (e.g. 30 seconds). The difference between a current high bid and any new bid submitted may also need to meet a preestablished minimum bid increment. In other words, new bids may be required to be at least a minimum amount of money (e.g. $5 or $100) more than the existing high bid. To encourage bidders to submit a bid higher than the minimum increment over the existing high bid, and to speed up the auction process in order to encourage more bidders to participate, bid buttons that allow a bidder to quickly and easily bid higher than the minimum increment are displayed on each online bidders' screen. To encourage a bidding “frenzy,” a countdown timer is displayed on each online bidders' screen during the virtual auction. Additionally, words or phrases associated with auctions, such as “going, going, gone”, may be displayed on the computer screen and/or audibly available to the online bidders. The virtual auction continues until each item offered during the preliminary bidding portion has been individually auctioned to its conclusion.

Bidders who participate in the preliminary bidding portion have the option of authorizing a computer server to submit bids on their behalf up to a specified maximum amount. In other words, the bidder authorizes the computer server to act as a proxy to submit bids on behalf of the bidder. If the bidder causing a proxy bid to be submitted is the high bidder during the preliminary bidding portion, the computer server will continue to submit higher bids, if necessary, during the virtual auction portion. The system automatically bids for the bidder until the maximum proxy bid is exceeded or the bidding stops at or below the maximum bid amount. In a similar manner, the proxy bid feature may also be utilized during the preliminary auction portion.

Online bidders may also request that they be alerted that a particular item is about to become the subject matter of the virtual auction. In this manner, online bidders do not have to pay attention to numerous individual auctions related to items which they do not have an interest. The alert may be in the form of a subtle audible alarm, a telephone call, a flashing PC display, instant messaging or some other notification means. In general, any means for alerting the bidder is applicable.

While disclosed briefly above, the auction system comprises many features and attributes which are disclosed in greater detail below.

### BRIEF DESCRIPTION OF THE DRAWINGS

FIG. 1A is an illustration of a conventional global computer network;

FIG. 1B is an illustration of one embodiment of the present invention, which utilizes both the internet and the public telephone network;

FIG. 2 is an illustration of a bidder screen accessed during a preliminary auction portion of the embodiments of the auction system;

FIG. 3A is an illustration of a bidder screen during a virtual auction portion of the embodiments of the auction system;

FIG. 3B is another illustration of a bidder screen during a virtual auction portion of the embodiments of the auction system;

FIG. 3C is an illustration of an alternative embodiment of the bidder screen during a virtual auction portion of the embodiments of the auction system;

FIG. 3D is another illustration of an alternative embodiment of the bidder screen during a virtual auction portion of the embodiments of the auction system;

FIG. 4 is an illustration of a bid matrix; and

FIG. 5 is a flowchart detailing the functionality of the voice recognition component of the present invention.

### DETAILED DESCRIPTION

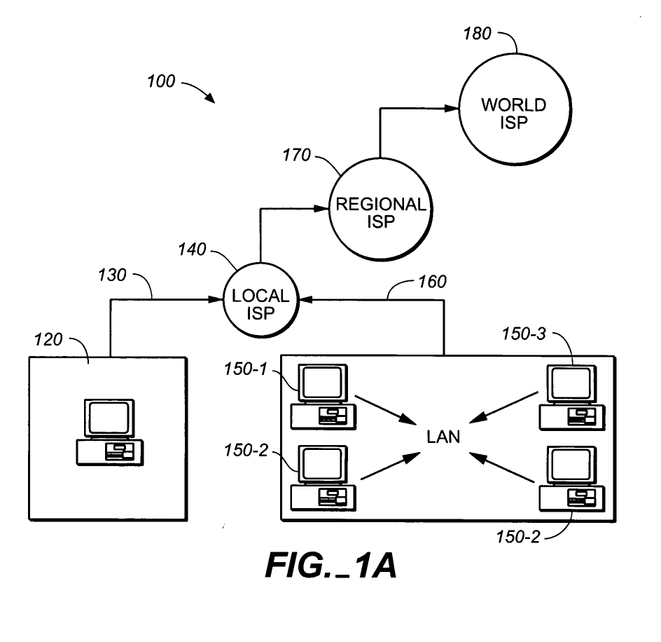

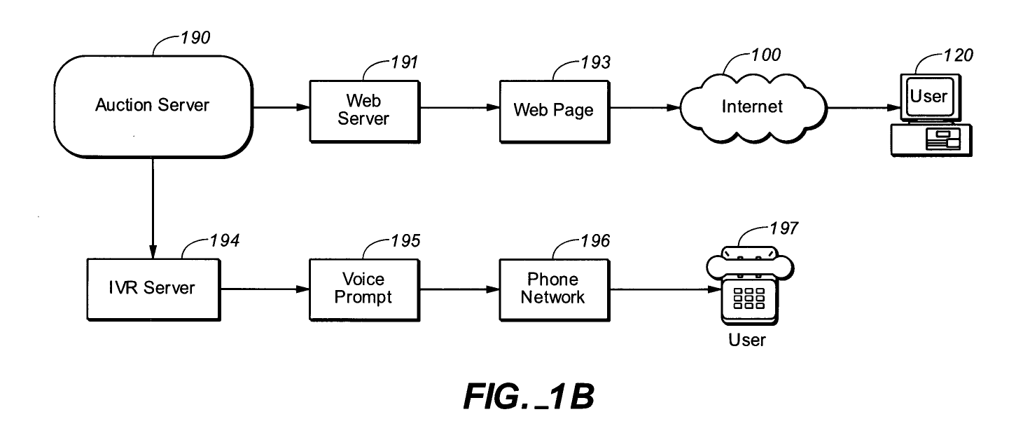

Reference is now made to the figures wherein like parts are referred to by like numerals throughout. A conventional global computer network generally depicted in FIG. 1A as reference numeral 100 includes a plurality of computers linked to one another. The network 100 allows all of the computers to communicate with one another. For example, a home personal computer (PC) 120 may be linked to the network 100 (e.g. the Internet) via a phone-line modem, DSL or cable modem 130 that talks to a local internet service provider (ISP) 140. In a business environment, the business will usually have a network interface card (NIC) that directly connects to a local area network (LAN) inside the business. The LAN comprises a plurality of local computers 150-1 through 150-N. The business can then connect its LAN to the local ISP 140 using a high-speed phone like a T1 line 160.

Each local ISP 140 then connects to a larger regional ISP 170 so that the larger regional ISPs 170 connect a geographic region. The regional ISPs 170 are then connected to even larger ISPs 180 which connect the world. In this way, every computer on the Internet is connected to every other computer on the Internet.

To keep all of the computers straight, each computer on the Internet is assigned a unique address called an Internet Protocol (IP) address. The IP address comprises a string of numbers. Since most people have trouble remembering the strings of numbers that make up an IP address, and since IP address sometimes need to change, all servers on the Internet also have human-readable names. The servers provide services including software applications to user machines (i.e. non-server computers).

The embodiments of the present invention are facilitated by the Internet and the public-switched telephone system, but do not include altering these networks as they operate today. Therefore, for the sake of brevity, the minute details of these networks and their operation are not set forth herein.

As used herein, the terms “component,” “module,” “logic,” and other terms similarly used can refer to implementations of the described features and method steps in hardware, software, firmware, or some combination thereof. Thus, any of these terms may refer to software applications or portions thereof, circuitry, ASICs (application-specific integrated circuits), processors configured to execute in a particular manner, and so on.

In a first embodiment of the present invention, an auction comprises a preliminary bidding component and a virtual auction component. In the preliminary bidding component, online bidders access the IP address/domain name corresponding to a website offering the auction service. Once the bidder has accessed the website, they may be required to register for the auction. The registration process may include the bidder providing personal or business information (e.g. name, address, telephone number, etc.), providing a method of payment (e.g. credit card number, bank account number, etc.) in case the bidder prevails with respect to specific item or items and any other information necessary to implement the online auction, such as a user name and password allocation. Once the registration process is completed the bidder is provided access to items up for bid. It is further envisioned that a registered bidder may be able to access a preliminary auction and a virtual auction by clicking on identified icons or windows displayed on an auction website or website linked to the auction website.

All items offered for bid are assigned to a particular auction date and time and are grouped on a “sale list” with other items assigned to the same date and time. Each item is accompanied by a written description and at least one or more static pictures of the item. Optionally, bidders may view a video type presentation of the item. Alternatively and additionally, bidders may be provided with access to a dynamic picture that may be rotated through 360 degrees allowing a complete view thereof. The specific presentation of the item is based on the preference of the specific website offering the auction. The objective is to provide bidders with a full and complete understanding of the item and its condition so that the bidders may make an educated bid.

During the preliminary bidding portion of the auction, bidders may enter bids on any item contained on the sale list until the preliminary bidding portion ends at a preestablished time. For example, the preliminary bidding portion may last as little as one day, but more often the preliminary bidding portion will last longer (e.g., two weeks) so that bidders can review and enter bids on an item in an open bid format. Preliminary bidding typically ends at some preestablished time prior to the scheduled start time of the virtual auction. A current high bid, along with a minimum required bid increment and lowest possible allowed bid, is displayed for the bidder to review. Thus, during the preliminary bidding portion, bidders are free to input bids on any of the items desired.

During the preliminary bidding portion of the auction, bidders may also input proxy bids. Proxy bids are bids that indicate the bidder is willing, if necessary, to bid up to a maximum amount specified by the bidder. Proxy bids are usually, but not always, a fair amount above the current bid. Therefore, if the current bid is $100, a bidder may input a proxy bid of $250 indicating that the bidder is willing to pay up to $250 to purchase the item. During the preliminary bidding portion of the auction, the website, or more precisely the website server will, on behalf of the bidder who submitted the proxy bid, submit bids in the minimum bid increment (e.g., $10) in response to each higher bid submitted by another bidder. However, the bidder's bid never automatically increases above the $250 proxy bid. In the aforementioned example, the proxy bidder's first bid may be automatically input as $110 (i.e., $10 more than the previous high bid). If another bidder inputs a $120 bid, the server automatically increases the proxy bidder's bid to $130. This procedure continues until a bid exceeds $250, at which time the proxy bidder is eliminated since the bid has exceeded his or her maximum bid amount, or the proxy bidder's input bid, which is less than or equal to $250, causes all other bidders to stop bidding. As described in detail below, regardless of the outcome of the preliminary bidding portion of the auction, the item remains available for auction during the virtual auction portion. In other words, the item has not been sold. If in the same example, the preliminary bidding ends at $200 and the proxy bidder is the high bidder, the server will continue to submit proxy bids, not to exceed $250, on behalf of the bidder during the virtual auction.

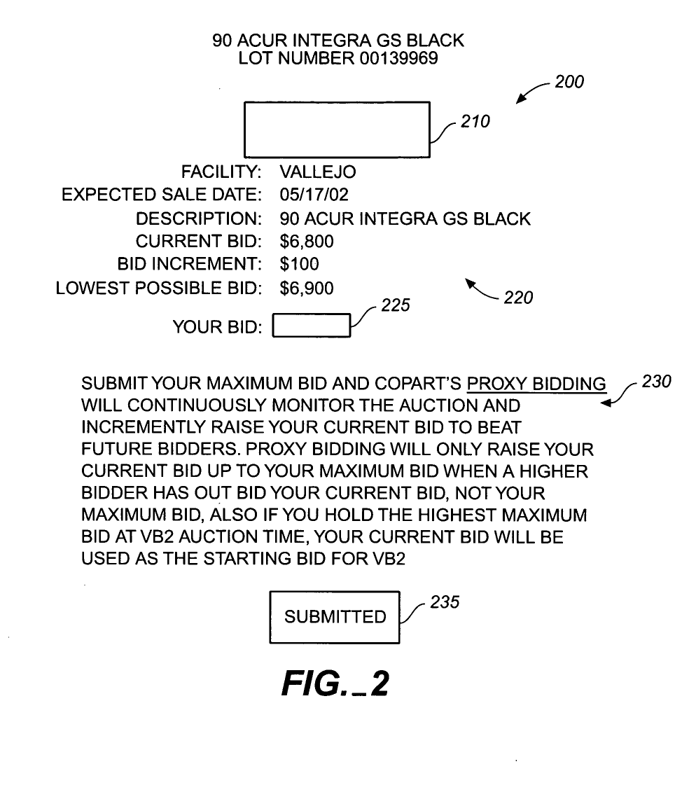

Now referring to FIG. 2, a bidder screen 200 accessed during a preliminary bidding portion of the embodiments of auction system is shown. It is noted that the bidder screen 200 is probably not the first screen that online bidders will see when they access a website offering the auction. In most instances, the first page is likely an auction company screen that provides bidders and other online users with information related to the auction company and links to other materials of interest, including sale lists. Also, the first page includes a link to the bidder screen 200 or an indirect link reachable by first viewing a sale list or some other method of locating the desired items for viewing and bidding.

In a first embodiment, the bidder screen 200 is accessible only after the aforementioned registration process has been completed and after the item has been selected from the auction sale list of has otherwise been located through various search functions provided on the website. Ideally, to access the bidder screen 200, the bidder must input the username and password selected during the registration process. The screen 200 includes item pictures 210, a written description of the item 220, a bid entry window 225 and a submit bid icon 235. The screen also includes instructions 230 regarding proxy bidding. Proxy bidding monitors the auction and increments a bidder's bid pursuant to a maximum input bid. Thus, once the proxy bid reaches the bidder's maximum bid, the proxy bidder stops placing incremental bids for the bidder. The screen may also display a countdown timer (not shown) displaying the amount of time remaining for the preliminary bidding portion of the auction and a time window (not shown) for showing a start time of the virtual auction portion. Alternatively, a proxy bid window for allowing bidders to place proxy bids may be displayed on screen 200. Optionally, the screen 200 may also include an icon for rotating the item pictures 210 or an icon for playing a streaming video depiction of the item being auctioned. The screen may also display a bid log for displaying the preliminary bidding history as explained, with respect to the virtual auction portion, in more detail below.

The bid entry window 225 allows bidders to enter bids. The bid entry window 225 treat bids in excess of the next bid increment as proxy bids. For example, if the current high bid is $500 by a first bidder and the minimum required bid increment is $50, the next bid should be $550. However, if a second bidder decides to enter a bid of $1000, the bid is treated as a proxy bid. Thus, the current high bid is set at $550 and credited to the second bidder. If the first bidder then bids $600, the system automatically increases the second bidder's bid to $650. This continues until the second bidder is the high bidder with no further bids forthcoming or until the second bidder's $1000 bid is exceeded. Thereafter, if desired, the second bidder may enter another bid or series of bids.

The length of time of the preliminary bidding portion of the auction is determined by the entity or individual controlling the website offering the auction. It is contemplated that the length of time should be in terms of days to permit the items to be viewed and studied by all interested parties. Nonetheless, there are no explicit time frame parameters.

The operations of the website (i.e., the countdown timer, the rotation of the pictures, access to various screens, etc.) offering the embodiments of the present invention are controlled by a server corresponding to the website. The server provides the software and other computer technology necessary to control the operation of the website and its many features. Since such website operations and corresponding servers are well known in the industry, they do not need to be intimately described herein.

Once the preliminary bidding portion of the auction has ended, no more bids may be input by online bidders. After the end of the preliminary bidding portion of the auction, the virtual portion of the auction is set to begin. Screen 200 includes a start time for the virtual portion of the auction. The time between the end of the preliminary bidding portion and the start of the virtual portion is again determined by the operator of the website offering the auction.

In one embodiment, the preliminary bidding portion of the auction is conducted through an interactive voice recognition (“IVR”) system. In a preferred embodiment, illustrated in FIG. 1B, software executes a series of dialogs that interact with the bidders, proactively assisting them to re-bid on items they have been outbid on. The bidders may call into the IVR system 194 using telephone 197 over the public telephone network 196, or the IVR system 194 may initiate contact with a bidder by dialing the bidder's telephone number. In either case, once the call is connected over the phone network, the VoiceXML infrastructure of the IVR system 194 acts as a browser and begins making a series of requests to a web server 192 for VoiceXML dialog, audio, grammar, and other documents. The web server 192 generates the VoiceXML documents populated with the information obtained from the backend process and responds to VoiceXML infrastructure with these documents. Once retrieved, the VoiceXML interpreter within the IVR system 194 executes the VoiceXML application and engages in a conversation with the bidder, who is connected to the auction system via a telephone 197 through the public telephone network 196. The bidder may use telephone 197 as an alternative (or as an adjunct) to computer 120, which obtains web pages 193 from the web server 191 via the internet 100. The bidder may communicate with the IVR system 194 using voice or the buttons on a touch-tone telephone.

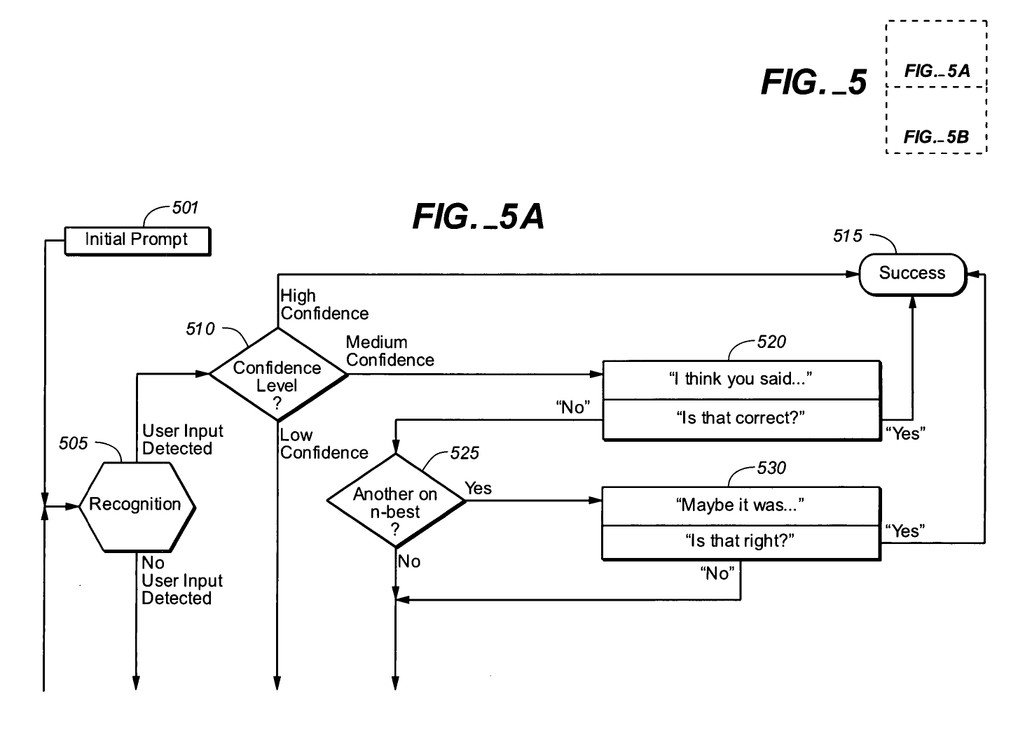

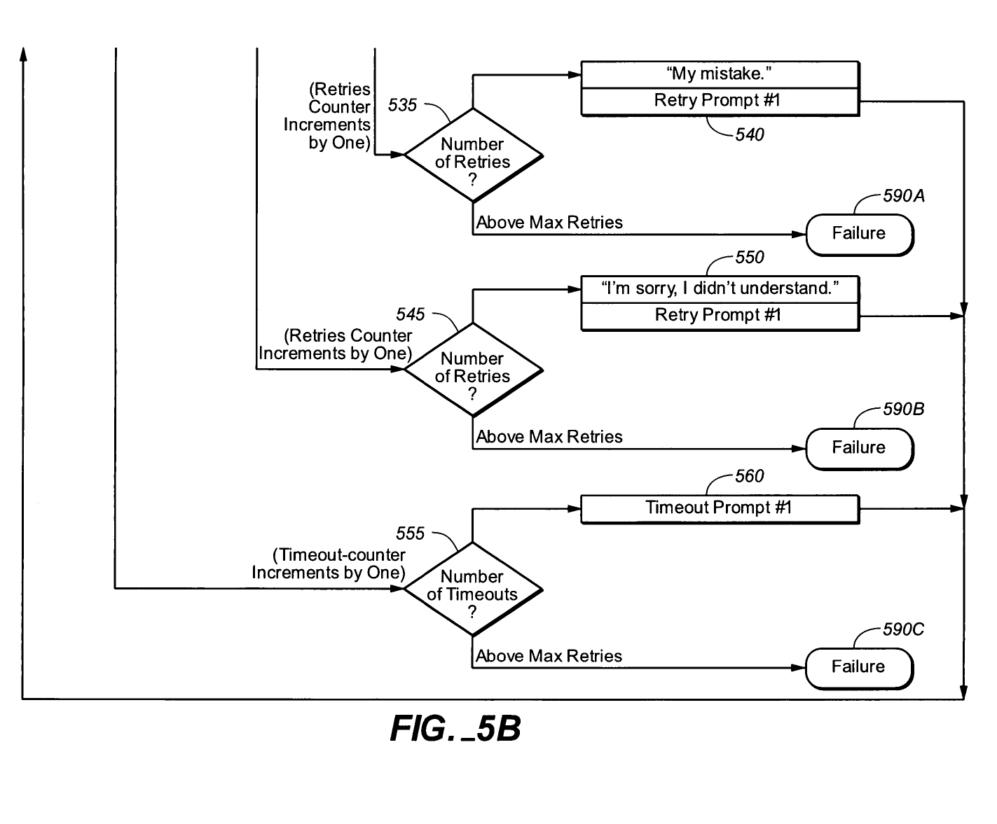

With reference to FIG. 5, the conversation may include various round trips back to the web server, where information that had been collected from the bidder is posted back for further processing and the web server responds with a new round of VoiceXML and other documents. The content of the conversation between the IVR system and the bidder varies from bidder to bidder and call to call, driven by how the bidder responds to prompts from the initial and follow-up dialogs and how the backend process responds to the bidder's inputs.

For instance, the system may begin with an initial prompt 501. It will then wait to recognize voice input from the bidder at box 505. If user input is detected, at box 510 the system determines the confidence level it has in its interpretation of the input received. This confidence may be determined by, for instance, comparing a digitized representation of the voice input with a predetermined digitized voice sample of a known command. If the system has high confidence in its interpretation, the input has been a success (box 515) and the system can base a response on that interpretation. If it has medium confidence in the interpretation, it prompts the bidder to confirm the input using box 520. Upon confirmation, the input has been a success. If the bidder states that clarification is necessary, the system will determine whether it has another understanding of the input at box 525. If so, the system prompts for confirmation of that additional understanding at box 530, which could lead to a successful input. If not, the system will play an apology message 540, and return to recognition box 505. If the system is unable to understand the input after a predefined maximum number of retries, tested at box 535, the input will be deemed a failure at box 590A. If the system has low confidence in its interpretation at box 510, the system will play a failure message 550, and return to recognition box 505. If the system is unable to understand the input after a predefined maximum number of retries, tested at point 545, the input will be deemed a failure at box 590B. If, at box 505, the system does not detect voice input, the system will play a timeout message 560, and return to recognition box 505. If the system is unable to detect any input after a predefined maximum number of retries, tested at box 555, the input will be deemed a failure at box 590B.

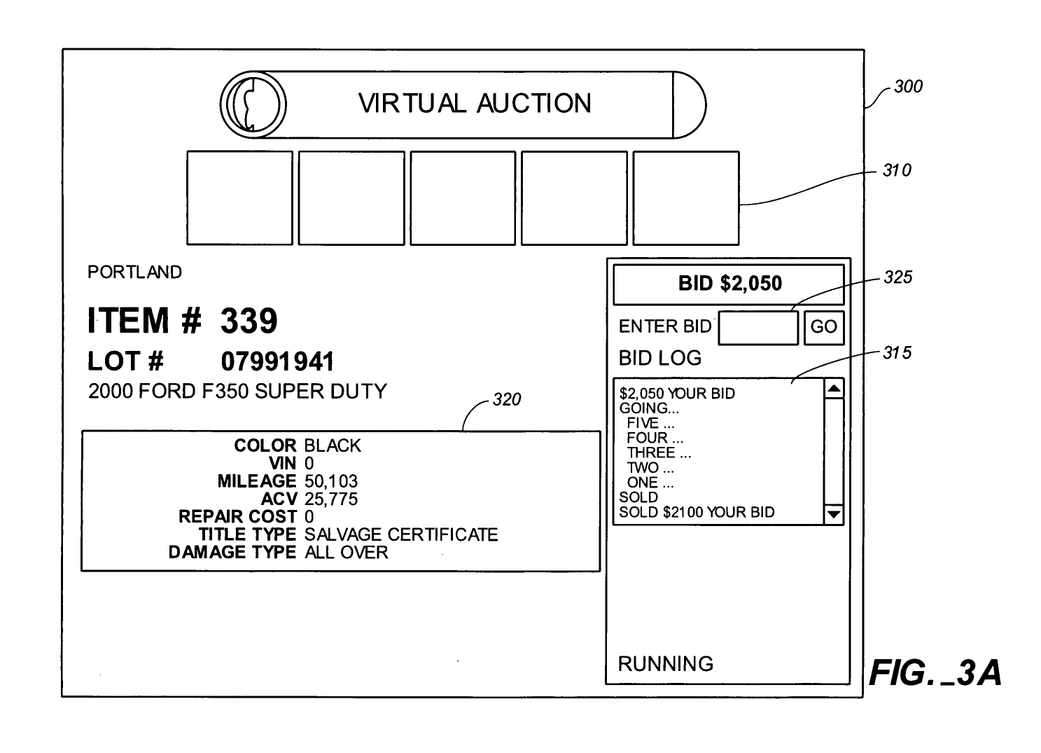

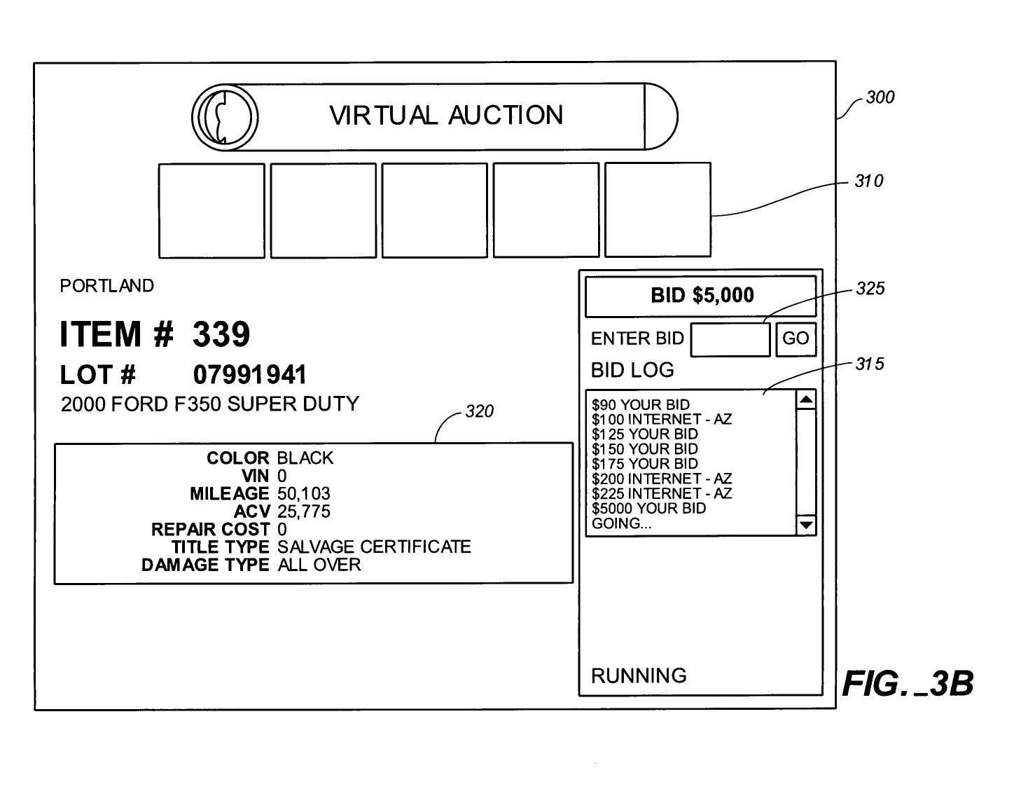

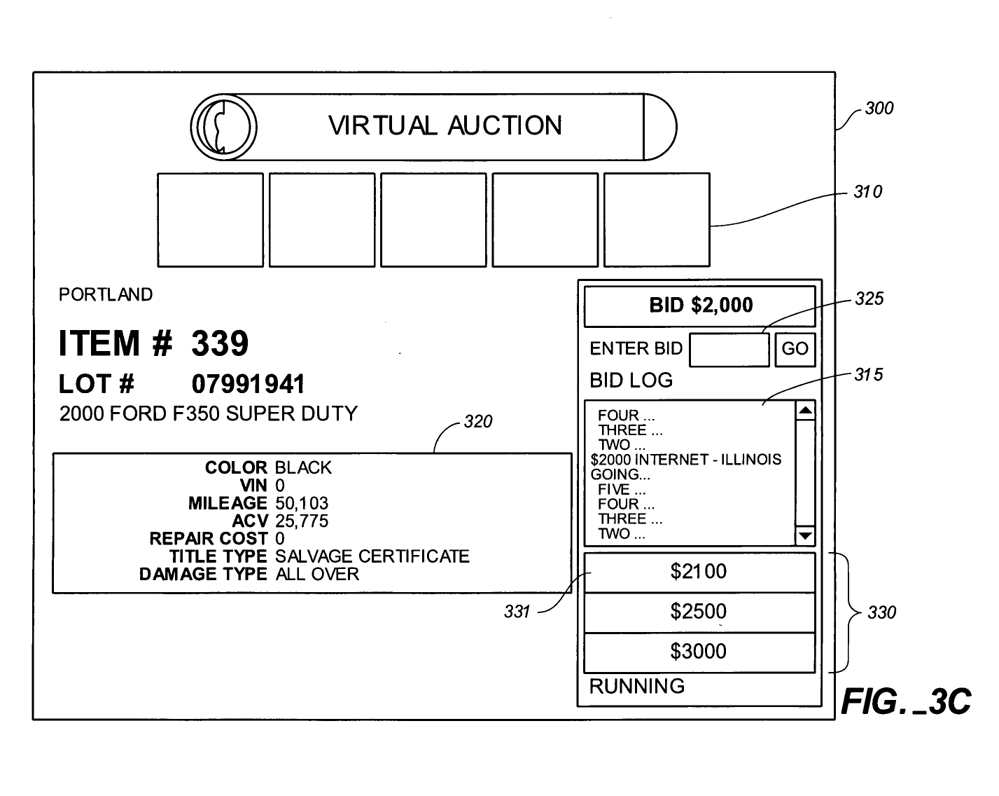

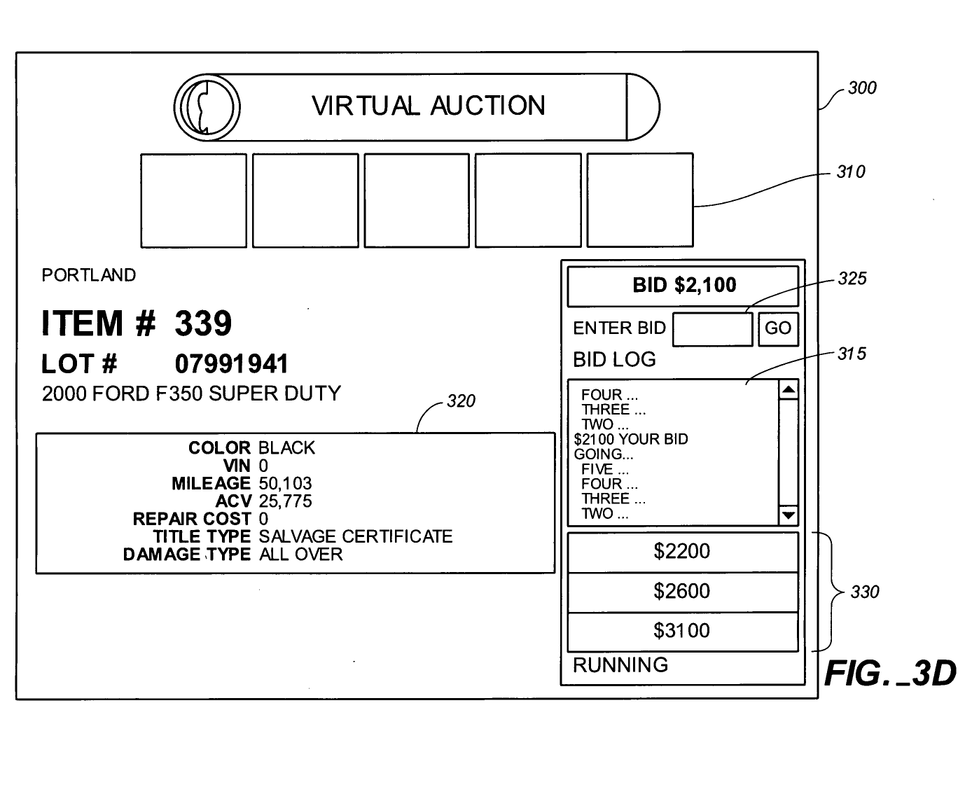

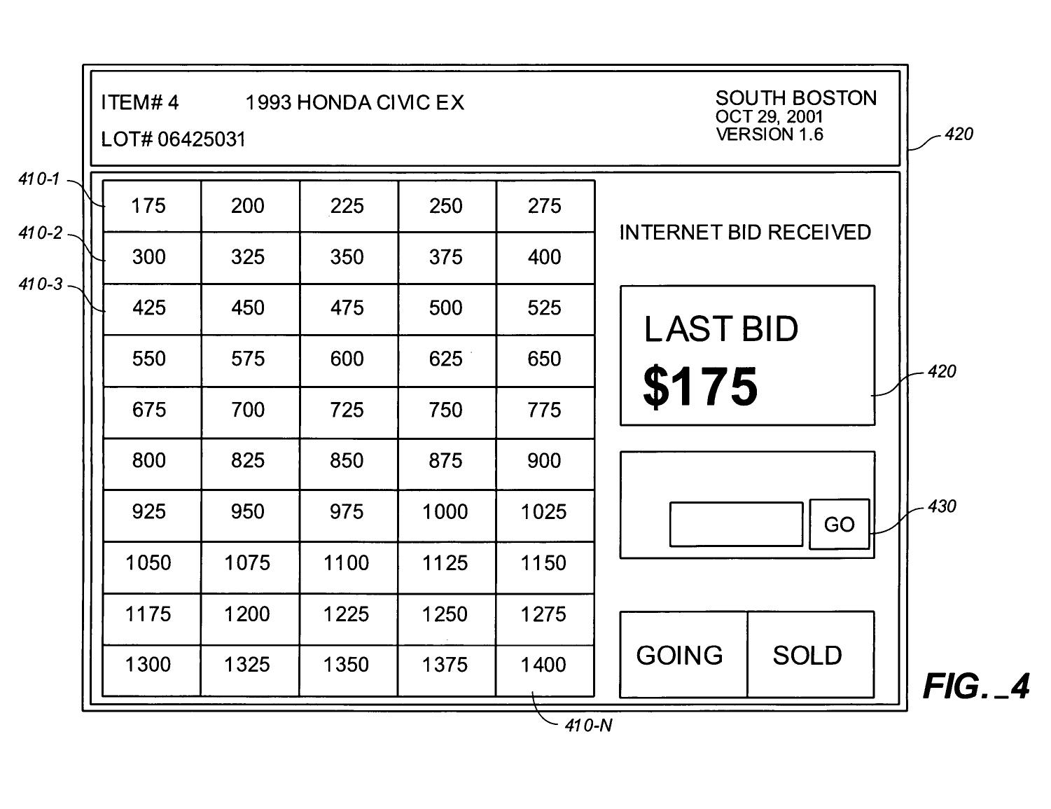

Now referring to FIG. 3A, a bidder screen 300 accessed during a virtual auction portion of the embodiments of the auction system is shown. The virtual auction proceeds in a manner analogous to a traditional live auction. In other words, the virtual auction takes place in real time with items being auctioned consecutively. However, unlike a traditional auction, the virtual auction begins with a higher opening bid which may be equal to the high bid obtained during the preliminary bidding portion of the auction. The auction time is drastically reduced because of the preliminary auction, which leads to a greater number of participants in the auction, with higher returns. However, the website server acts as the auctioneer and controls the auction. Once again, in a first embodiment, bidders need to be registered to gain access the virtual auction screen. If the bidder is already registered, they will only need to input their username and password to access the virtual auction screen 300. Thereafter, each item will be auctioned consecutively and individually until all items have been offered for auction. In practice, as soon as one item has been auctioned, the next item will be offered. The auction is controlled by the website server or similar device.

In alternative embodiments, the opening bid of the virtual auction may be less than the high bid obtained during the preliminary bidding portion of the auction, or higher than the high bid obtained during the preliminary bidding portion of the auction. In these embodiments, however, the opening bid of the virtual auction is based upon the bids obtained during the preliminary bidding portion of the auction, using a percentage, dollar amount, or other determination of an increase or decrease (which, of course, may be zero). In one embodiment, for instance, the opening bid of the virtual auction may be equal to the high bid obtained during the preliminary bidding portion of the auction. In another embodiment, the opening bid of the virtual auction may be equal to the second highest bid obtained during the preliminary bidding portion of the auction. In yet another embodiment, the opening bid of the virtual auction may be 10% higher than the high bid obtained during the preliminary bidding portion of the auction.

The virtual auction screen 300 includes item pictures 310, a bid log 315, a written description of the item 320 and a bid entry window 325. The bidding history in the bid log 315 starts with the current bid from the preliminary auction portion which is indicated as the “starting bid.” The bid log 315 is the focal point of the virtual auction portion because, as shown in FIGS. 3A through 3D, it identifies each bid, the location of the corresponding bidder and a countdown sequence to indicate that the item is about to be sold if no further bids are received. For example, as shown in FIG. 3A, the countdown may show Five, Four, Three, Two, One and SOLD to inform bidders that they must submit another bid quickly or lose the item. When any bid is received during the countdown sequence, the countdown ceases and resets a preestablished number of seconds later. If no bids are received during the countdown sequence, the item is sold. If no bids are submitted during the virtual auction portion, the high bidder from the preliminary bidding portion is awarded the item as the high bidder. As set forth above, bidders may also need to input a bid that is a preestablished increment (e.g. $5) more than the previous bid. Thereafter, the next item up for auction from the sale list is displayed and the bid log 315 shows the “starting bid”.

While the amount of time allotted between bids may remain constant (e.g. thirty seconds), it may also be decreased, as the bidding advances, to minimize the length of the virtual auction. For example, the time between bids may be incrementally decreased to only fifteen seconds should the virtual bidding continue for a preestablished length of time such as three minutes. The decreased amount of time between bids will encourage bidders to input bids that they are confident will prevail. In any event, the time allotted between bids is arbitrary but should be a sufficient time to allow bidders a realistic opportunity to input a new higher bid.

To further encourage a bid “frenzy” the screen 300 may also display words or phrases associated with the virtual auction. For example, as the bid log 315 counts down, the screen 300 may further display the phrase “going, going, gone” to encourage bidders to input additional bids. Alternatively, the words or phrases can be audibly reproduced by the speakers of a networked PC. In this manner, the audible words and phrases have the effect of creating a live auction environment.

It is also contemplated that the geographic location of individual bidders may be displayed or enunciated over the networked computers as shown in FIG. 3B. By providing the geographic location of the bidders, the auction's magnitude is reinforced thereby promoting the concept being offered. In essence, the geographic indicator is free public relations informing the bidders of the mass appeal of the auction site. Thus, one or more bidders may desire to use the website to auction off his or her own goods.

The screen 300 may include bid buttons 330, as shown in FIGS. 3C and 3D, which provide a selection of bids available to the bidder. These buttons encourage bidders to submit a bid higher than the minimum preestablished increment over the existing high bid. These buttons also create a faster auction, which encourages more participants in the auction, a greater “frenzy” during the auction, and higher returns. When clicked, these buttons automatically submit the bid amount displayed on the button to the server. The system updates the bid amounts displayed on these buttons as the existing high bid changes. For example, in FIG. 3C, where the high bid is $2,000, the buttons may display $2,100, $2,500, and $3,000. FIG. 3D shows how the display may change after the button 331 ($2,100) is clicked—the bid log 315 reflects that the last bid made was $2,100; the high bid is listed as $2,100; and the bid buttons 330 now display $2,200, $2,600, and $3,100 as the amounts associated with these bids. Although in the examples above only three bid buttons are displayed, fewer bid buttons or more bid buttons could be displayed on any specific screen 300.

In a first embodiment of the auction system, any unused proxy bid authority remaining from the high bidder of the preliminary bidding portion of the auction is carried over to the virtual auction portion. In the same manner as the preliminary bidding portion, the server acts to automatically input a bid for the proxy bidder until the maximum amount has been reached. Optionally, proxy bidders may instruct the server that proxy bids are not to be carried over to the virtual auction portion. In fact, screen 200 and/or screen 300 may include an icon or window for bidders to decline or accept carrying their proxy bids from the preliminary auction portion to the virtual auction portion. The virtual auction can allow for proxy bids to be submitted during the virtual auction, or in the alternative can treat any submitted bid that is higher than the required minimum bid as a straight bid to be submitted directly into the auction.

In the first embodiment, each item presented during the preliminary auction portion is also presented during the virtual auction portion. Since items are auctioned consecutively during the virtual auction portion, there will be a delay between the start time of the virtual auction portion and the time certain items are offered during the later stages of the virtual auction. Therefore, the embodiments of the present system incorporate a method for providing bidders with notice that a specific item is about to be offered for bid as part of the virtual auction. Screen 200 and/or screen 300 incorporate an identification number entry window for bidders to enter item identification numbers associated with specific items being auctioned. Based on the item identification numbers input by the bidders, the system is instructed that certain bidders are interested in being notified that the certain specific items are about to be offered for bid as part of the virtual auction. As most bidders will be using PCs with corresponding speakers, the bidders may be alerted by an audible alarm indicating that the item of interest is about to be offered for auction. Alternatively, a flashing PC screen, a telephone call, pager alert or instant messaging may be used to alert the bidder. Any suitable manner of notification is contemplated herein.

The timing of said alerts, like the time allowed between bids, is arbitrary but should be enough time to allow bidders to return to their PCs (or other network device) and input bids. For example, the alert may begin five minutes before the item is expected to come up for auction, or alternatively when there are only five items up for bid prior to the auction for the item of interest.

To increase the ease and speed of inputting bids during the virtual auction portion, a bid matrix as shown in FIG. 4 may be incorporated on screen 300. The bid matrix 400 holds a preestablished collection of individual bids 410-1 through 410-N which are incremented in a pre-set format to correspond to the item up for bid. In this manner, the bidder simply clicks on, or moves a displayed indicator icon to, a desired bid causing that bid to be automatically input. Besides the use of a computer mouse or keyboard keys, a touchscreen may also be used to select the desired input bid. The matrix 400 eliminates the need for bidders to input a dollar value of bids which may require three or more key strokes and may lead to errors.

The particular values associated with the individual bids 410-1 through 410-N are a function of the initial virtual auction bid (i.e. the final preliminary auction bid) of the specific item being offered. Moreover, the difference between successive individual bids 410-1 through 410-N is also a function of the initial bid of the specific item being offered. In other words, a high priced item may have a larger separation between bids 410-1 through 410-N than a lower priced item. The bid matrices may be, based on a anticipated bid, predetermined for each item being auctioned or may be generated in response to the initial virtual auction bid. Such predetermined matrices are beneficial in situations when a minimum bid has been established such that the matrix 400 of individual bids 410-1 through 410-N can be anticipated. Alternatively, as set forth above, the bid matrix 400 may be generated in response to the initial virtual auction bid. In this manner, a library of pre-generated matrices may be stored on the server or similar storage device prior to the auction and may automatically be retrieved based on the initial virtual auction bid. Alternatively, the bid matrix 400 may be originally generated in response to the initial virtual auction bid by a server application.

Although the invention has been described in detail with reference to a preferred embodiment, additional variations and modifications exist within the scope and spirit of the invention as described and defined.

1. An auction system, comprising:
a preliminary bidding component configured to offer for auction a plurality of items for a preestablished duration of time in a preliminary auction, the preliminary bidding component further configured to accept bids for the items from remote bidders during the preliminary auction; and
a dynamic real-time virtual auction component configured to execute after the preliminary auction, the dynamic real-time virtual auction component configured to offer for auction items that were offered for auction in the preliminary auction whereby an initial asking price on each item is based upon a bid for the item received during the preliminary auction, the dynamic real-time virtual auction component further configured to accept bids for the items from remote bidders and to automatically update the display to remote bidders as the dynamic real-time virtual auction proceeds.

2. The system of claim 1, wherein the preliminary bidding component is configured to communicate with the remote bidders over a computer network.

3. The system of claim 1, wherein the preliminary bidding component is configured to communicate with the remote bidders over a telephone network.

4. The system of claim 1, wherein the preliminary bidding component is configured to communicate with the remote bidders using an interactive voice recognition component.

5. The system of claim 4, wherein the interactive voice recognition component is configured to dial a remote bidder's telephone number.

6. The system of claim 5, wherein the interactive voice recognition component is further configured to execute a dialog, receive input from the remote bidder, determine an interpretation of the input with a confidence level, and proceed with follow up dialogs based upon the confidence level.

7. The system of claim 6, wherein if the confidence level is high, the follow up dialogs are configured based upon the interpretation of the input.

8. The system of claim 6, wherein if the confidence level is medium, the follow up dialogs are configured to prompt the remote bidder to confirm the interpretation of the input.

9. The system of claim 8, wherein additional follow up dialogs are configured based upon the interpretation of the input if the remote bidder confirms the interpretation of the input.

10. The system of claim 8, wherein the interactive voice recognition component is further configured, if the remote bidder fails to confirm the interpretation of the input, to determine a second interpretation of the input and prompt the remote bidder to confirm the second interpretation of the input.

11. The system of claim 10, wherein additional follow up dialogs are configured based upon the second interpretation of the input if the remote bidder confirms the second interpretation of the input.

12. The system of claim 10, wherein the interactive voice recognition component is further configured, if the remote bidder fails to confirm the second interpretation of the input, to execute an apology message and a dialog to prompt the remote bidder to re-enter the input.

13. The system of claim 6, wherein if the confidence level is low, the follow up dialogs are configured to prompt the remote bidder to re-enter the input.

14. The system of claim 1, wherein the preliminary bidding component is configured to communicate with the remote bidders over both a computer network and a telephone network.

15. The system of claim 1, wherein the dynamic real-time auction component is configured to communicate with the remote bidders over a computer network.

16. The system of claim 1, wherein the dynamic real-time auction component is configured to communicate with the remote bidders over a telephone network.

17. The system of claim 1, wherein the dynamic real-time auction component is configured to communicate with the remote bidders over both a computer network and a telephone network.

18. The system of claim 1, 16, or 17, wherein the dynamic real-time auction component is additionally configured to track bids made by bidders present at a central physical location.

19. The system of claim 1, further comprising buttons displayed on a screen used by a remote bidder during the dynamic real-time auction component, the buttons being configured to provide a selection of bids available to the remote bidder.

20. The system of claim 19, wherein the buttons are configured to display bid amounts that are higher than a current high bid.

21. The system of claim 20, wherein the bid amounts are configured to change upon a change in the current high bid.

22. A method of conducting an auction, including the steps of:
offering preliminary bidding on items wherein a plurality of items are offered for auction for a preestablished time period in a preliminary auction;
accepting bids for the items from remote bidders during the preliminary auction;
offering a dynamic real-time virtual auction beginning after the preliminary auction wherein items offered for auction during the preliminary auction are offered for auction with an initial asking price for each item based upon a bid for the item received during the preliminary auction; and
accepting bids for the items from remote bidders during the dynamic real-time virtual auction and automatically updating the display to remote bidders as the dynamic real-time virtual auction proceeds.

23. The method of claim 22, wherein the preliminary auction is conducted over a computer network.

24. The method of claim 22, wherein the preliminary auction is conducted over a telephone network.

25. The method of claim 22, wherein the preliminary auction accepts bid from remote bidders through an interactive voice recognition component.

26. The method of claim 25, wherein the interactive voice recognition component dials a remote bidder's telephone number, executes a dialog, receives input from the remote bidder, determines an interpretation of the input with a confidence level, and proceeds with additional dialogs based upon the confidence level.

27. The method of claim 26, wherein the confidence level is high, and the additional dialogs are based upon the interpretation of the input.

28. The method of claim 26, wherein the confidence level is medium, and a first additional dialog prompts the remote bidder to confirm the interpretation of the input.

29. The method of claim 28, wherein other additional dialogs are based upon the interpretation of the input if the remote bidder confirms the interpretation of the input.

30. The method of claim 28, wherein the interactive voice recognition component, if the remote bidder fails to confirm the interpretation of the input, determines a second interpretation of the input and prompts the remote bidder to confirm the second interpretation of the input.

31. The method of claim 30, wherein other additional dialogs are based upon the second interpretation of the input if the remote bidder confirms the second interpretation of the input.

32. The method of claim 30, wherein the interactive voice recognition component, if the remote bidder fails to confirm the second interpretation of the input, executes an apology message and a dialog to prompt the remote bidder to re-enter the input.

33. The system of claim 26, wherein the confidence level is low, and the additional dialogs prompt the remote bidder to re-enter the input.

34. The method of claim 22, wherein the preliminary auction is conducted over a computer network and a telephone network.

35. The method of claim 22, wherein the dynamic real-time auction is conducted over a computer network.

36. The method of claim 22, wherein the dynamic real-time auction is conducted over a telephone network.

37. The method of claim 22, wherein the dynamic real-time auction is conducted over a computer network and a telephone network.

38. The method of claim 22, wherein the dynamic real-time auction is conducted over a computer network and in person.

39. The method of claim 22, wherein the dynamic real-time auction is conducted over a computer network, a telephone network, and in person.

40. The method of claim 22, further comprising displaying buttons on a screen of each remotely located bidder during the dynamic auction, the buttons providing a selection of bids available to the bidder.

41. The method of claim 40, wherein the buttons display bid amounts which are higher than a current high bid.

42. The method of claim 41, wherein the bid amounts change upon a change in the current high bid.

43. An auction system, comprising:
a first component configured to run an auction including a preliminary bidding component configured to offer for auction a plurality of items for a preestablished duration of time in a preliminary auction and a dynamic real-time virtual auction component configured to execute after the preliminary auction; and
a second component connected to the first component and to a computer network, the second component configured to deliver web pages to a remote user over the computer network,
wherein the dynamic real-time virtual auction component is configured to offer for auction items that were offered for auction during the preliminary auction, and wherein an initial asking price for each item is based upon a bid for the item received during the preliminary auction, and wherein the second component is configured to update the display to remote bidders as the dynamic real-time virtual auction proceeds.

44. The system of claim 43, further comprising a third component connected to the first component and to a telephone network, the third component configured to deliver voice prompts to a remote user over the telephone network.

45. The system of claim 43, wherein the initial asking price is set to be equal to a high bid for the item received during the preliminary auction.

46. The system of claim 43, wherein the initial asking price is set to be less than a high bid for the item received during the preliminary auction.

47. The system of claim 43, wherein the initial asking price is set to be greater than a high bid for the item received during the preliminary auction.

48. A method of conducting an auction using a processor-based system, including the steps of:
displaying information regarding a plurality of items offered for auction during a preliminary auction lasting for a preestablished time period;
receiving input during the preliminary auction which corresponds to bids for the items;
conducting a dynamic real-time virtual auction beginning after the preliminary auction ends in which items offered for auction during the preliminary auction are offered for auction with an initial asking price set based upon a bid received during the preliminary auction;
receiving input during the dynamic real-time virtual auction which corresponds to bids for the items; and
updating the display to remote bidders as the dynamic real-time virtual auction proceeds.

49. The method of claim 48, further comprising displaying buttons on a screen of each remotely located bidder during the dynamic real-time auction, the buttons being configured to provide a selection of bids available to the bidder.

50-62. (canceled)
